(19) United States
(12) Patent Application Publication
(10) Pub. No.: US 2010/0239469 A1
(43) Pub. Date: Sep. 23, 2010

(54) Monolithic exhaust treatment unit for treating an exhaust gas

(76) Inventors: Keith Olivier, Jackson, MI (US); Ruth Latham, Ann Arbor, MI (US); Benedikt Mercker, Heuchelheim-Klingen (DE); Steven Freis, Ann Arbor, MI (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/383,152

(22) Filed: Mar. 20, 2009

(51) Int. Cl. B01D 53/34

(52) U.S. Cl. 422/180

(57) ABSTRACT

A monolithic exhaust treatment device on unit (10) is provided for treating an exhaust gas (12) from a combustion process (14), and is part of an exhaust gas treatment system (16), which can include other exhaust gas treatment components (18). The monolithic exhaust treatment unit (10) includes a monolithic structure (20), at least two layers (22) of support mat (24), and at least one layer (26) of metallic foil (28) sandwiched between the two layers (22) of support mat (24).

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to monolithic exhaust treatment devices or units in the form of particulate filters such as gasoline particulate filters and diesel particulate filters (DPF), and catalytic units for treating an exhaust gas from a combustion process, such as, for example, catalytic converters, diesel oxidation catalysts (DOC), and selective catalytic reduction catalysts (SCR) for the compression engines of on and off-road vehicles, locomotives, and stationary power applications, and more particularly, to such monolithic exhaust treatment units wherein a support or mounting mat is placed around an outer circumferential surface of a monolithic filter or monolithic catalytic carrier structure for supporting the structure within a housing.

### BACKGROUND OF THE INVENTION

It is known in the automotive industry to include an exhaust gas treatment system utilizing gasoline particulate filters or diesel particulate filters and/or one or more catalytic units, such as a catalytic converter, diesel oxidation catalyst unit, or selective catalytic reduction catalyst unit to improve the emissions in the exhaust. In such catalytic units, it is common for a catalyst to be carried as a coating on a supporting substrate structure, such as a ceramic substrate having a monolithic structure, and in particulate filters it is common to employ a monolithic filter structure that can be non-catalytic. Typically, such monolithic structures are oval or circular in cross section and are often wrapped with a layer of a support or mounting mat that is positioned between the monolithic structure and the outer housing of the unit to help protect the monolithic structure from shock and vibrational forces that can be transmitted from the housing to the monolithic structure. Typically, the support or mounting mat is made of a heat resistant and shock absorbing type material, such as a mat of glass fibers, ceramic fibers, or rock wool. While such constructions work for their intended purpose, there is always room for improvement.

### SUMMARY OF THE INVENTION

In accordance with one feature of the invention, a monolithic exhaust treatment unit is provided for treating an exhaust gas from a combustion process. According to a further feature, an exhaust gas treatment system is provided for a combustion process and includes the monolithic exhaust treatment unit. The monolithic exhaust treatment unit includes a monolithic structure having an outer surface extending parallel to a longitudinal axis, at least two layers of support mat wrapped around the outer surface, and at least one layer of metallic foil sandwiched between the at least two layers of support mat.

As one feature, the monolithic exhaust treatment unit further includes an outermost layer of metallic foil wrapped around an outermost layer of support mat.

In one feature, the monolithic exhaust treatment unit further includes a housing surrounding an outermost layer wrapped around the catalyst carrier.

According to one feature, the monolithic structure has a circular cross section centered on the longitudinal axis.

As one feature, the monolithic structure includes a catalyst.

According to one feature, the monolithic structure includes a ceramic substrate.

In one feature, the monolithic structure includes a porous structure.

As one feature, at least a portion of the metallic foil is perforated.

According to one feature, the metallic foil defines edge seals that extend over adjacent edges of the support mat at one or both ends of the monolithic exhaust treatment unit.

In one feature, all the layers of support mat are separated by at least one layer of metallic foil.

Other objects, features, and advantages of the invention will become apparent from a review of the entire specification, including the appended claims and drawings.

### BRIEF DESCRIPTION OF THE DRAWINGS

FIG. 1 is a somewhat diagrammatic representation of an exhaust gas treatment system for a combustion process and includes a monolithic exhaust treatment unit embodying the present invention;

FIG. 2 is an enlarged view taken from line 2-2 in FIG. 1;

FIG. 3 is a view similar to FIG. 2, but showing an alternate embodiment of the monolithic exhaust treatment unit;

FIGS. 4A and 4B are somewhat diagrammatic representations illustrating one method of assembling the monolithic exhaust treatment unit of FIGS. 1-3;

FIG. 5 is a view taken from line 5-5 showing a portion of one component of the monolithic exhaust treatment unit of FIGS. 1-4;

FIGS. 6-12C are enlarged, partial views taken from line 6-6 in FIG. 1 showing several possible constructions for the monolithic exhaust treatment unit of FIG. 1 that include one or more edge seals.

### DETAILED DESCRIPTION OF THE PREFERRED EMBODIMENT

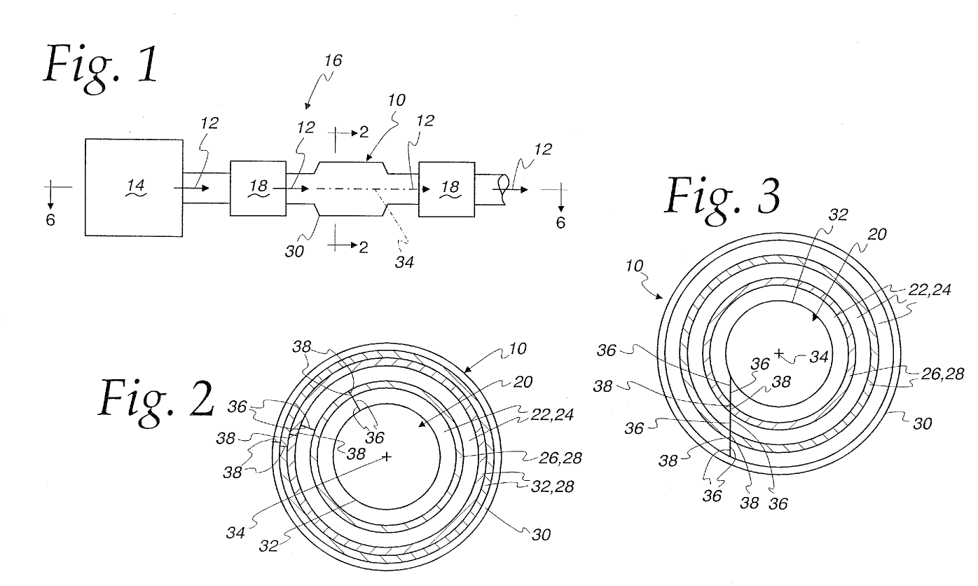

With reference to FIG. 1, a monolithic exhaust treatment device or unit 10 is shown for treating an exhaust gas 12 from a combustion process, such as from a combustion compression engine 14. The monolithic exhaust treatment unit 10 is part of an exhaust gas treatment system 16, which can include other exhaust gas treatment components 18, either upstream or downstream or both from the monolithic exhaust treatment unit 10. The components 18 can be of any suitable type and construction and can include mufflers, diesel particulate filters, injectors, and valves, such as exhaust gas recirculation valves, by way of a few examples.

As seen in FIG. 2, the monolithic exhaust treatment unit 10 includes a monolithic structure 20, at least two layers 22 of support mat 24, and at least one layer 26 of metallic foil 28 sandwiched between the two layers 22 of support mat 24, and an outer housing 30. As shown in FIG. 2, preferably, one or more layers 32 of metallic foil 28 are also included between the outermost layer 22 and the housing 30. However, as shown by the construction in FIG. 3, in some applications it may be desirable to have the outermost layer 22 be directly adjacent the housing 30.

Preferably, the metallic foil 28 reduces the effective thermal conductivity between the layers 22 and from the monolithic structure 20 and exhaust gas 12, as well as reducing the radiant heat transfer from the monolithic structure 20 and exhaust gas 12. This can be very beneficial for maintaining the temperature of the exhaust gas 12 and the monolithic structure 20 within temperature ranges that are suitable, and preferably optimal, for a desired catalytic reaction(s) if the monolithic structure 20 includes a catalyst. In some applications, it may be desirable that the metallic foil not substantially reduce the effective thermal conductivity between the layers and/or from the monolithic structure 20 and exhaust gas 12.

While the monolithic structure 20 can be of any suitable type and construction, many of which are known, in the preferred embodiments shown in FIGS. 2 and 3, the monolithic structure 20 is a monolithic structure of porous ceramic carrying a catalyst coating that is suitable for the intended function of the unit 10, such as, for example, a suitable oxidation catalyst or a suitable selective catalytic reduction catalyst.

Preferably, the monolithic structure 20 has an outer surface 32 that extends parallel to a longitudinal axis 34, best seen in FIG. 1, which will typically coincide with the flow direction of the exhaust 12 through the unit 10. While any suitable cross section can be used, including for example oval, elliptical, triangular, rectangular, and hexagonal, the preferred embodiments shown in FIGS. 2 and 3 have circular cross sections that are centered on the axis 34 to define a cylindrical shape for the monolithic structure 20 and the outer surface 32.

Each layer 22 of support mat 24 may be made from any suitable material, many of which are known, including, for example, glass fiber mats, rock wool mats, or ceramic fiber mats, such as for example, refractory ceramic fibers, mullite ceramic fibers, or other high alumina ceramic fibers. In some applications, it may be desirable for each layer 22 to be made from the same mat material, while in other applications it may be desirable for one or more of the layers 22 to be made from a mat material that differs from the mat material of any other layer 22. Preferably, the supporting mat 24 of each layer 22 has a circumferential length that extends between two abutted circumferential ends 36 that can either be squared as shown in FIG. 2 or tapered as shown in FIG. 3. However, in some applications, it may be desirable for each layer 22 to be formed as a sleeve that is continuous in the circumferential direction. Furthermore, in some applications, it may be desirable for the support mat to be a continuous length that is spiral wound about the monolithic structure 20 with the metallic foil also being a continuous length that is also spiral wound about the monolithic structure 20 in between each of the layers 22 formed by the spiral winding of the support mat 24.

Each layer 26 and 32 of the metallic foil 28 can be made from any suitable metallic material, such as, for example, stainless steel foil or aluminum foil. If the unit 10 includes more than one layer 26, 32, it may be desirable in some applications for each layer 26, 32 to be made from the same metallic foil material, while in other applications it may be desirable for at least one of the layers 26, 32 to be made from a metallic foil material that differs from the metallic foil material of any other layer 26, 32. Preferably, the metallic foil 28 of each layer 26, 32 has a circumferential length that extends between abutted ends 38 that can either be squared as shown in FIG. 2 or tapered as shown in FIG. 3. Furthermore, the ends 38 can be circumferentially aligned with the ends 36 of the adjacent layers 22, 26, 32 as shown in FIG. 3 and as shown for the two innermost layers 22 and 26 of FIG. 2, or they can be offset from the ends 36 of the adjacent layers 22, 26, 32 as shown for the outermost layers 22, 32 of FIG. 2, depending upon the requirements and parameters of each particular application. As with the layers 22, in some applications it may be desirable for each layer 26 to be formed as a sleeve that is continuous in the circumferential direction. Additionally, in some applications it may be desirable for the metallic foil 28 to be laminated onto the support mat 24 prior to wrapping the mat 24 and foil 28 around the monolithic structure 20.

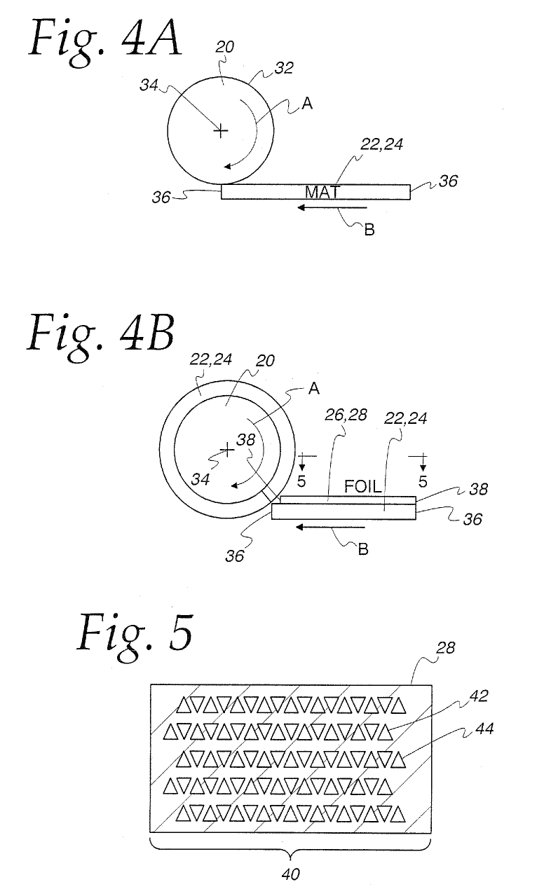

With reference to FIGS. 4A and 4B, one method of assembling the monolithic exhaust treatment unit 10 is to wrap a first layer 22 of the support mat 24 around the monolithic structure 20 by rotating the monolithic structure 20 about the axis 34, as shown by arrow A, while supplying the mat 24 at a suitable speed, as shown by arrow B, and then wrapping a layer 26 of metallic foil 28 together with a second layer 22 of support mat 24 while rotating the monolithic structure 20 and the first layer 22 together about the axis 34 and providing the foil 28 and mat 24 at a suitable speed, again as shown by arrows A and B. Alternatively, each of the layers 22 and 24 can be wrapped sequentially about the monolithic structure 20 as individual layers, or provided as a single sandwiched structure that is wrapped simultaneously about the monolithic structure 20.

With reference to FIG. 5, a portion 40 of metallic foil 28 for one of the layers 26 or 32 is shown to illustrate an optional construction wherein an array of perforations 42 are provided in the portion 40 to increase the friction between the metallic foil 28 and any adjacent layer 22, 26 or 32. In this regard, it is preferred that the perforations 42 be formed by puncturing the foil 28 to form raised edges 44 at the peripheries of the perforations 42. In some applications, it may be desirable for the raised edges to all be located on one side of the foil 28, while in other applications it may be desirable for the raised edges 44 to be on one side of the foil 28 for some of the perforations 42, and on the opposite side of the foil 28 for others of the perforations 42. It is also possible to increase the friction by bunching the foil 28, burring the foil 28, punching the foil 28, dimpling the foil 28, or using other types of surface roughening treatments on the foil 28. The portion 40 can extend over a limited circumferential length of the foil 28 or over the entire circumferential length of the foil 28, depending upon the parameters of each application. It should be understood that such frictional enhancements may not be desirable in some applications for all or any of the layers 26 or 32.

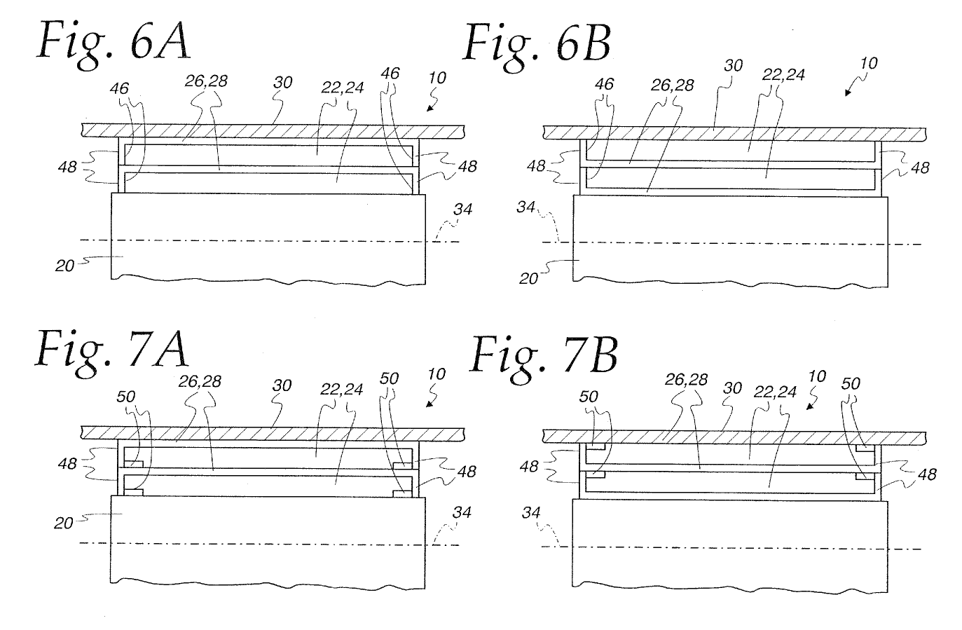

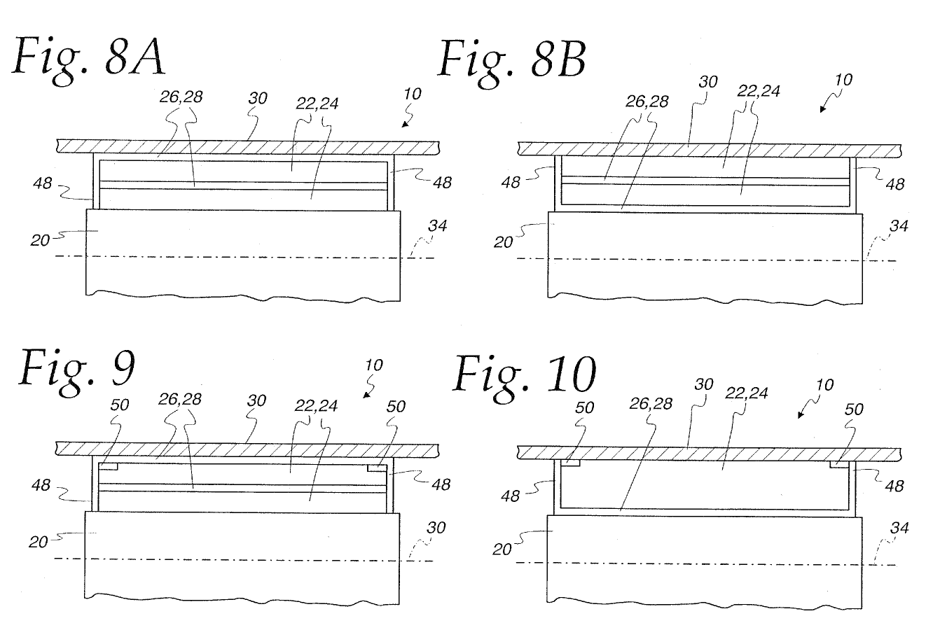

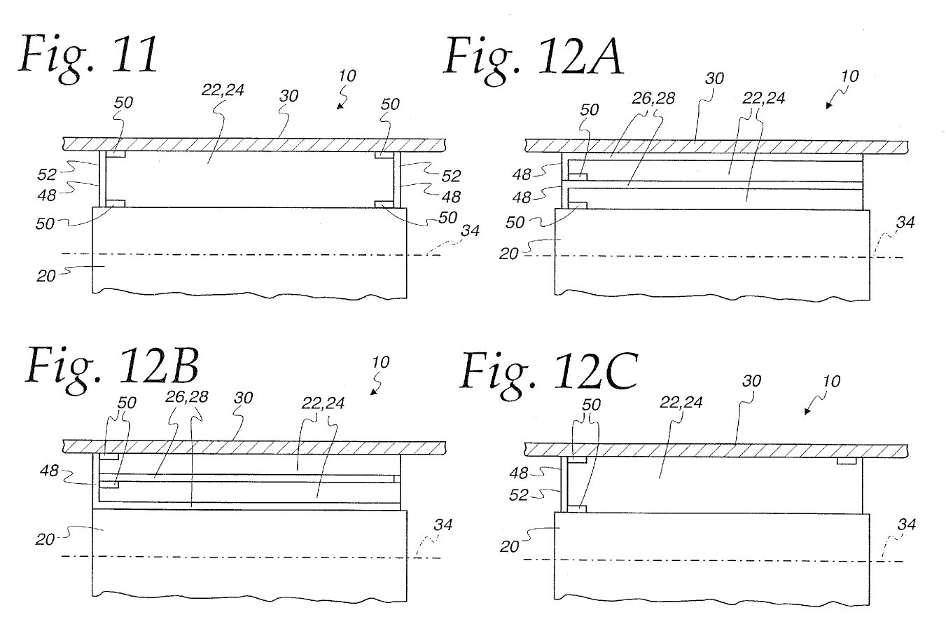

With reference to FIGS. 6A and 6B, another option is shown wherein the metallic foil 28 of each layer 26 extends longitudinally beyond each longitudinal edge 46 of the adjacent support mat 24 to define edge seals 48 over the edges 46 of the adjacent support mat 24 to limit intrusion of the exhaust gas 12 into the support mat 24. In FIG. 6A, the outer edges of each layer 26 are folded in a radially inward direction to define the edge seals 48, while in FIG. 6B the edges of each layer 26 are folded in a radially upward direction to form the edge seals 48. FIGS. 7A and 7B are similar to FIGS. 6A and 6B, but additional foil strips 50 have been added to provide additional structure for the edge seals 48 by abutting the folded edges of each of the layers 26. FIGS. 8A and 8B show another option wherein the metallic foil 28 of either the innermost layer 26 or the outermost layer 26 is extended far enough to be folded either radially inwardly or radially outwardly to form the edge seals 48 extending over both of the layers 22 of support mat 24. FIG. 9 illustrates the concept of FIGS. 8A and 8B in connection with the strips 50 of FIGS. 7A and 7B. FIG. 10 illustrates an embodiment wherein the edge seal 48 is provided with a single layer 22 of the support mat 24 and a single layer 26 of the metal foil 28, and FIG. 11 illustrates an embodiment that does not utilize the layers 26, but does utilize two of the strips 50 in combination with an edge foil 52 to define the edge seals 48. It should be appreciated that in some applications it may be desirable for the edge seals or seal 48 to be provided on only one end of the support mats 24 for any of the above embodiments, with some examples of such constructions being shown in FIGS. 12A, 12B and 12C.

It should be appreciated that by providing one or more of the layers 26, 32, the performance of the monolithic exhaust treatment unit 10 can be enhanced in comparison to conventional monolithic exhaust treatment units by providing better thermal isolation within and from the unit 10.

1. A monolithic exhaust treatment unit for treating an exhaust gas from a combustion process, the monolithic exhaust treatment unit comprising:
a monolithic structure having an outer surface extending parallel to a longitudinal axis;
at least two layers of support mat wrapped around the outer surface; and
at least one layer of metallic foil sandwiched between the at least two layers of support mat.

2. The monolithic exhaust treatment unit of claim 1 further comprising an outermost layer of metallic foil wrapped around an outermost layer of support mat.

3. The monolithic exhaust treatment unit of claim 1 further comprising a housing surrounding an outermost layer wrapped around the monolithic structure.

4. The monolithic exhaust treatment unit of claim 1 wherein the monolithic structure has a circular cross section centered on the longitudinal axis.

5. The monolithic exhaust treatment unit of claim 1 wherein the monolithic structure comprises a catalyst.

6. The monolithic exhaust treatment unit of claim 1 wherein the monolithic structure comprises a ceramic substrate.

7. The monolithic exhaust treatment unit of claim 1 wherein the monolithic structure comprises a porous filter structure.

8. The monolithic exhaust treatment unit of claim 1 wherein at least a portion of the metallic foil is perforated.

9. The monolithic exhaust treatment unit of claim 1 wherein the metallic foil defines edge seals that extend over adjacent edges of the support mat at opposite ends of the monolithic exhaust treatment unit.

10. The monolithic exhaust treatment unit of claim 1 wherein all the layers of support mat are separated by at least one layer of metallic foil.

11. An exhaust gas treatment system for a combustion process, the system comprising a monolithic exhaust treatment unit for treating the exhaust gas, the monolithic exhaust treatment unit comprising:
a monolithic structure having an outer surface extending parallel to a longitudinal axis;
at least two layers of support mat wrapped around the outer surface; and
at least one layer of metallic foil wrapped between the at least two layers of support mat.

12. The system of claim 11 wherein the monolithic exhaust treatment unit further comprises an outermost layer of metallic foil wrapped around an outermost layer of support mat.

13. The system of claim 11 wherein the monolithic exhaust treatment unit further comprises a housing surrounding an outermost layer wrapped around the monolithic structure.

14. The system of claim 11 wherein the layers are defined by spiral wraps of support mat and metallic foil.

15. The system of claim 11 wherein at least a portion of the metallic foil is perforated.

16. The system of claim 11 wherein the metallic foil defines edge seals that extend over adjacent edges of the support mat at opposite ends of the monolithic exhaust treatment unit.

17. The system of claim 11 wherein all the layers of support mat are separated by at least one layer of metallic foil.
